(19) United States
(12) Patent Application Publication
(10) Pub. No.: US 2011/0061380 A1
(43) Pub. Date: Mar. 17, 2011

(54) Motor Vehicle Internal Combustion Engine EGR Loop

(76) Inventors: Samuel Leroux, Poissy (FR); Laurent Albert, Vallangoujard (FR)

(21) Appl. No.: 12/811,120

(22) PCT Filed: Dec. 18, 2008
(86) PCT No.: PCT/FR08/01779

§ 371 Date: Nov. 30, 2010

(30) Foreign Application Priority Data
Jan. 3, 2008 (FR) FR 0800025

(51) Int. Cl. F02B 33/44; F02M 25/07

(52) U.S. Cl. 60/605.2; 123/568.12

(57) ABSTRACT

An EGR loop of an internal combustion engine of a motor vehicle, comprising the engine (1), a combustion-gas exhaust manifold (2), a turbine (5) of a turbocharger (4), the exhaust gas recirculation (EGR) loop (8), with a cooler (9), a compressor (6) of the turbocharger (4), in order to receive a portion of the exhaust gases and of the cool air and in which the pressure of the mixture is increased, an inlet manifold (3) of the engine (1) in order to receive the air from the compressor (6), with a particle filter (7) for cleaning the exhaust gases downstream of the turbine (5) and a low-pressure, single-flap, three-way valve (10). The valve (10) is placed upstream of the compressor (6), connected thereto via its outlet (17) in order to receive, at its two inlets (15, 16), cool air and the cleaned and cooled exhaust gases.

The invention relates to an EGR loop of an internal combustion engine of a motor vehicle, comprising the engine, a combustion-gas exhaust manifold, a turbine of a turbocharger, the exhaust gas recirculation (EGR) loop, with a cooler, a compressor of the turbocharger, receiving a portion of the exhaust gases and of the cool air and in which the pressure of the mixture is increased, an inlet manifold of the engine receiving the air from the compressor.

The EGR loop is intended to reduce the emission of nitrogen dioxide by reducing the combustion temperature, by a slowing of the combustion of the oxidant mixture and absorbing a portion of the calories. The cooler of the EGR loop makes it possible to reduce the combustion temperature at high engine speed (high load).

Usually, the EGR loop comprises a low-pressure, three-way valve downstream of the turbine of the turbocharger and a particle filter for retaining the soot that is in the exhaust gases before regeneration of the gases thus cleaned.

The originality of the invention lies in the fact that it is born of a problem that is particular but that has then been neglected in order to define the invention.

Hitherto, the particle filter was close to the engine, and even incorporated into the engine, and the EGR valve was downstream of the exhaust. As an EGR valve, three-way valves with one flap (single-flap) and three-way valves with two flaps (double-flap) are known but are more complex.

The problem that the applicant set itself is the distancing of the particle filter from the engine, that is to say in the passageway of the exhaust line under the bodyshell of the vehicle, and hence the problem of returning the cleaned gases to the engine.

It is in this situation that the applicant has had the idea of moving the single-flap, three-way EGR valve from the exhaust to the inlet, in other words from downstream of the turbine to upstream of the compressor of the turbocharger but without linking this movement to the position of the particle filter relative to the engine.

Therefore, the invention relates to an EGR loop of the type mentioned above, with a particle filter for cleaning the exhaust gases downstream of the turbine and a low-pressure, single-flap, three-way valve, said loop being characterized in that the valve is placed upstream of the compressor, connected thereto by its outlet and receiving, at its two inlets, cool air and the cleaned and cooled exhaust gases.

By virtue of the invention, the three-way EGR valve is a cold valve and no longer hot, which is a lower-cost valve, with electronics which no longer need to be cooled.

In the preferred embodiment of the EGR loop of the invention, the three-way valve and its single flap are arranged in order to operate according to one of the three modes i) inlet into the engine of cool air only, ii) inlet of a mixture of air and of EGR gases and iii) inlet of EGR gases only.

The invention will be better understood with the aid of the following description of the preferred embodiment of the EGR loop of the invention, with reference to the drawing, in which

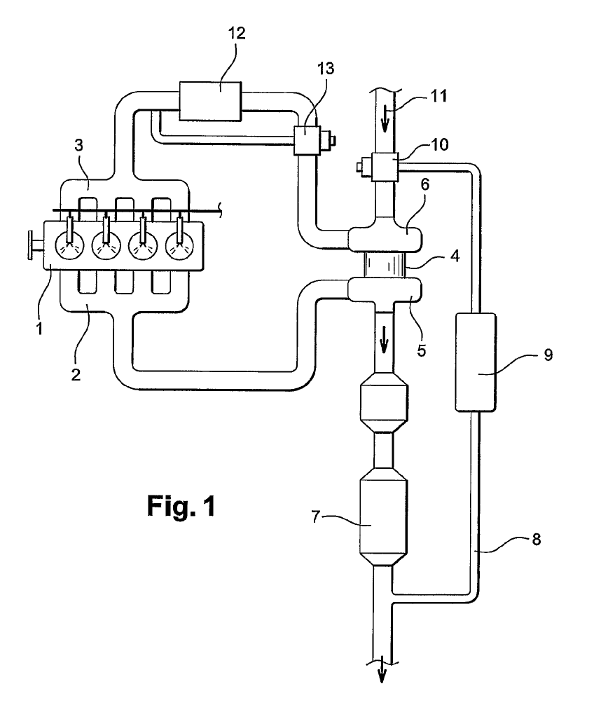

FIG. 1 represents, in a simplified manner, the EGR loop of the invention;

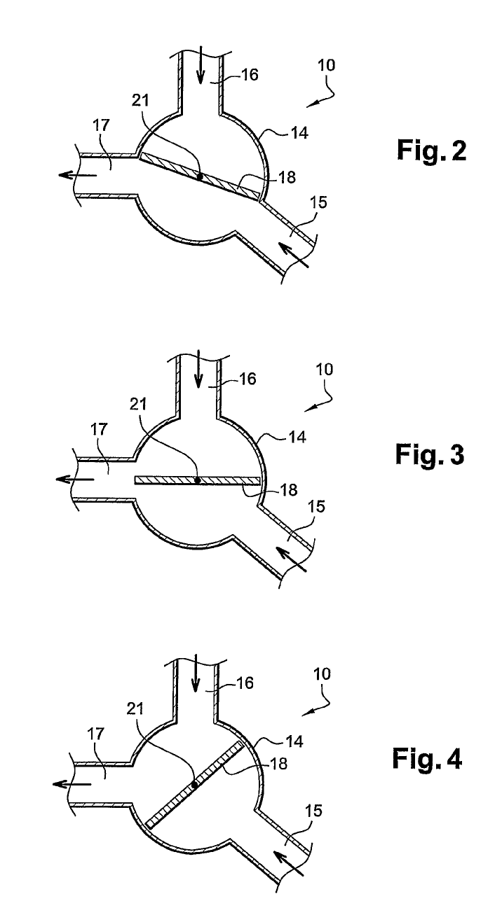

FIG. 2 represents the single-flap, three-way valve of the loop of FIG. 1 in a state of letting in cool air only;

FIG. 3 represents the single-flap, three-way valve of the loop of FIG. 1 in the state of letting in a mixture of cool air and of EGR gases, and

FIG. 4 represents the single-flap, three-way valve of the loop of FIG. 1 in a state of letting in EGR gases only.

The loop of FIG. 1 comprises a vehicle engine 1, with its exhaust manifold 2 and its inlet manifold 3, a turbocharger 4 with a turbine 5, downstream of the exhaust manifold, and a compressor 6 upstream of the inlet manifold, a particle filter 7, downstream of the turbine 5 which is connected, on the other side, to the muffler of the vehicle and to an EGR branch line 8, comprising in this instance an EGR cooler 9, and a low-pressure, three-way valve 10, connected via its outlet to the compressor 6 and, via its two inlets, to the outlet of the EGR cooler 9, and to a cool air inlet 11. The turbine 5 is rotated by the exhaust gases in order to drive in its turn the compressor 6, connected at the outlet to the inlet manifold 3, in this instance via a water-filled air cooler 12, which may also be short-circuited by means of a valve 13.

The low-pressure, three-way valve 10 comprises a body 14 connected to a first cool air inlet 15, to a second inlet 16 for cleaned and regenerated EGR exhaust gases and an outlet 17 which is connected to the inlet manifold 3 of the engine. The body 14 in this instance has a substantially circular cross section and a single flap 18 is mounted inside it so as to rotate about a spindle 21 under the action of an actuator (not shown). The flap 18 is adapted to completely or partly close off one or the other of the two inlets 15, 16. The actuator is controlled by a control system and position sensors are installed in the valve in order to determine the position of the flap 18.

In FIG. 2, only cool air (15) is taken into the inlet manifold 3. The inlet 16 is closed off by the flap 18.

In FIG. 3, a mixture of cool air (15) and of exhaust gases (16) is taken into the inlet manifold. The pressure drop between the inlet and the exhaust is sufficient to ensure a good EGR ratio.

In FIG. 4, in order to increase the pressure drop between the inlet and the exhaust and to ensure a good EGR ratio, only the exhaust gases are taken into the inlet manifold 3. The cool air inlet 15 is closed off by the flap 18.

The three-way valve 10 can have a configuration that differs from the present example but nevertheless without departing from the context of the invention, notably the ducts 15, 16, 17 may vary in number and in position. Likewise, the single flap 18 may have a curved shape or have several inclined edges, depending on the arrangement of these ducts 15, 16, 17.

1. An EGR loop of an internal combustion engine of a motor vehicle, comprising the engine (1), a combustion-gas exhaust manifold (2), a turbine (5) of a turbocharger (4), the exhaust gas recirculation (EGR) loop (8), with a cooler (9), a compressor (6) of the turbocharger (4), in order to receive a portion of the exhaust gases and of the cool air and in which the pressure of the mixture is increased, an inlet manifold (3) of the engine (1) in order to receive the air from the compressor (6), with a particle filter (7) for cleaning the exhaust gases downstream of the turbine (5) and a low-pressure, single-flap, three-way valve (10), the loop being characterized in that the valve (10) is placed upstream of the compressor (6), connected thereto via an outlet (17) of the valve (10) in order to receive, at two inlets (15, 16) of the valve (10), cool air and the cleaned and cooled exhaust gases.

2. The EGR loop as claimed in claim 1, wherein the three-way valve (10) and its single flap (18) are arranged to operate according to one of three modest i) inlet into the engine (1) of cool air only, ii) inlet of a mixture of air and of EGR gases, and iii) inlet of EGR gases only.
